(19) United States
(12) Patent Application Publication
(10) Pub. No.: US 2015/0321715 A1
(43) Pub. Date: Nov. 12, 2015

(54) Three Dimensional Flywheel Vehicle

(71) Applicant: National Tsing Hua University, Hsin Chu City (TW)

(72) Inventors: Jia-Ying TU, Kaohsiung City (TW); Cheng-En TSAI, Taichung City (TW); Chung-Chun HSIAO, New Taipei City (TW)

(21) Appl. No.: 14/491,987

(22) Filed: Sep. 20, 2014

(30) Foreign Application Priority Data
May 7, 2014 (TW) 103116280

(51) Int. Cl. B62D 63/02; B62D 57/02

(52) U.S. Cl. CPC B62D 63/025; B62D 57/02

(57) ABSTRACT

The invention proposes a three dimensional flywheel vehicle, comprising multiple spherical shells, including outer spherical shell, middle spherical shell and inner spherical shell, wherein each of spherical shell is 3D flywheel. At least one casting/frame is connected to the three spherical shells. The plurality of actuators comprises first actuator, second actuator and third actuator for actuating the outer shell, the middle shell and the inner shell, respectively. The first actuator, the second actuator and the third actuator are connected to one of the at least one casting/frame or one of the three spherical shells.

### CROSS-REFERENCE TO RELATED APPLICATION

This present application claims the benefit of the TAIWAN Patent Application Serial Number 103116280 of May 7, 2014, which are herein incorporated by reference in its entirety.

### TECHNICAL FIELD

The present invention generally relates to a mobile vehicle, more particularly, to an especially a three-dimensional flywheel vehicle which allows to control its direction of motion by utilizing multiple three-dimensional flywheels/multi-shells structure and a pendulum, which can also be used as a spherical robotics.

### BACKGROUND

Modern vehicle system equips with two, three or four wheels for contacting to ground to maintain its stability (static equilibrium). Kinetic energy of rotation by two-dimensional flywheels is transformed into reciprocating motion, meanwhile friction (grip) on tire is to procure vehicle moving forward continuously. However, design of multiple wheels makes steering mechanism, drive mechanism more complicated, and thereby increasing vehicle body weight. Single-wheel design is not suitable for carrying heavy loads and its applications are to be limited. Design of tire in contact with ground inevitably reduces energy consumption efficiency of flywheel.

In addition, when meeting an instantaneous strong impact, modern vehicle system design tends to squeeze front portion and rear portion of the vehicle body in order to absorb and dissipate the impact energy, thus maintaining integrity of the middle part of vehicle body and minimizing passenger casualties. However, if subjected to severe lateral impact, it is not easy to absorb impact energy effectively by squeezing and deforming vehicle body, preventing passenger casualties. Furthermore, modern vehicle system equips with two or four wheels to be driven, which needs at least two contact points with ground to generate frictional force (grip) and to move the vehicle forward, would consume power energy.

The modern vehicle system mentioned-above shows shortcomings, and therefore the invention proposes a new, safe and energy-saving design to overcome the traditional vehicle's shortcomings

### SUMMARY

As noted above, the invention provides a three dimensional flywheel and a mobile vehicle made by the three dimensional flywheels.

When the mobile vehicle is made by three-layer three-dimensional flywheels, whose movement principle is similar to a gyroscope system.

An object of the invention is to provide a three dimensional flywheel vehicle, when the vehicle is impacted by an external body, the impacted energy can be rapidly dispersed over the whole spherical shells.

Another object of the invention is to provide a three dimensional flywheel vehicle, wherein the structure of spherical shells can be used as three-dimensional flywheels to store rotational kinetic energy. The vehicle shell itself of the invention is a flywheel, so additional steering linkage mechanism is no need, reducing vehicle body's weight.

Yet another object of the invention is to provide a three dimensional flywheel vehicle, utilizing pendulum as the balance mechanism to change center of gravity of the vehicle body in order to control direction, and maintain stability or balance the vehicle motion. The invention proposes a new, safe and energy-saving design of three-dimensional flywheel vehicle to overcome the traditional vehicle's shortcomings.

According to an aspect of the invention, it proposes a three dimensional flywheel vehicle, comprising three spherical shells, including an outer shell, a middle shell and an inner shell, wherein the outer shell, the middle shell and the inner shell are constructed as outer layer, middle layer and inner layer of the vehicle, respectively. At least one joint structure is connected to the three spherical shells. A plurality of actuators which are comprised of a first actuator, a second actuator and a third actuator, are used for driving the outer shell, the middle shell and the inner shell, respectively. The first actuator, the second actuator or the third actuator is connected to or sliding joint to one of the at least one joint structure or one of the three spherical shells. The outer shell, the middle shell and the inner shell rotate around a first rotation axis, a second rotation axis and a third rotation axis, respectively.

In an aspect, the vehicle further comprises a platform disposed within the inner shell for dividing the inner shell into an upper chamber and a lower chamber. The upper chamber is equipped with a control panel, a monitoring screen, a main control room, and a cargo storage room. The lower chamber is equipped with electronic circuits, battery and power systems, servo controllers, sensing elements, and balancing mechanisms. The balancing mechanism includes a pendulum or a gyro.

In another aspect, one end of a first rotator of the first actuator is connected to the outer shell, one end of a second rotator of the second actuator is connected to the middle shell, and one end of a third rotator of the third actuator is connected to the inner shell.

In one aspect, the at least one joint structure is a single joint structure. A bottom of the first actuator/the second actuator/the third actuator is fixed on the single joint structure. The single joint structure is connected to one or more shells (outer shell/middle shell/inner shell). The middle shell can be made by two hemispherical structures.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a control operation process of a three-dimensional flywheel mobile carrier according to one embodiment of the invention;

FIG. 2 illustrates a front view of a three-dimensional flywheel mobile vehicle according to the first embodiment of the invention;

FIG. 3 illustrates a side view of a three-dimensional flywheel mobile vehicle according to the first embodiment of the invention;

FIG. 4 illustrates a top view of a three-dimensional flywheel mobile vehicle according to the first embodiment of the invention;

FIG. 5 illustrates a front view of a three-dimensional flywheel mobile vehicle according to the second embodiment of the invention;

FIG. 6 illustrates a side view of a three-dimensional flywheel mobile vehicle according to the second embodiment of the invention;

FIG. 7 illustrates a top view of a three-dimensional flywheel mobile vehicle according to the second embodiment of the invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention provides a three-dimensional flywheel vehicle which is a spherical mobile vehicle (shell rotation, three-dimensional flywheel), including three or more three-dimensional flywheels (3D spherical shells), and its main features and functions include: (1) when the vehicle is impacted by an external body, power source of all of the three-dimensional flywheels (3D spherical shells) is off, remaining only its inertia; (2) structure of a spherical shell can be used as a three-dimensional flywheel to store rotational kinetic energy; (3) vehicle steering system with a pendulum (and/or gyro) is capable of controlling vehicle steering, and maintaining the stability, static equilibrium and dynamic balancing of vehicle body; (4) the impacted energy can be rapidly dispersed over the whole spherical shells, to avoid severe damage and dent of the vehicle.

In one embodiment, the three-dimensional flywheel vehicle of the invention may be used as an automated patrol robotics.

In addition, vehicle shell itself of the invention is a flywheel, so additional steering linkage mechanism is no need, to reduce vehicle body's weight and mechanism complexity. Three-dimensional flywheel vehicle with avant-garde design, safety, energy-saving, of the invention can overcome the traditional vehicle's shortcomings.

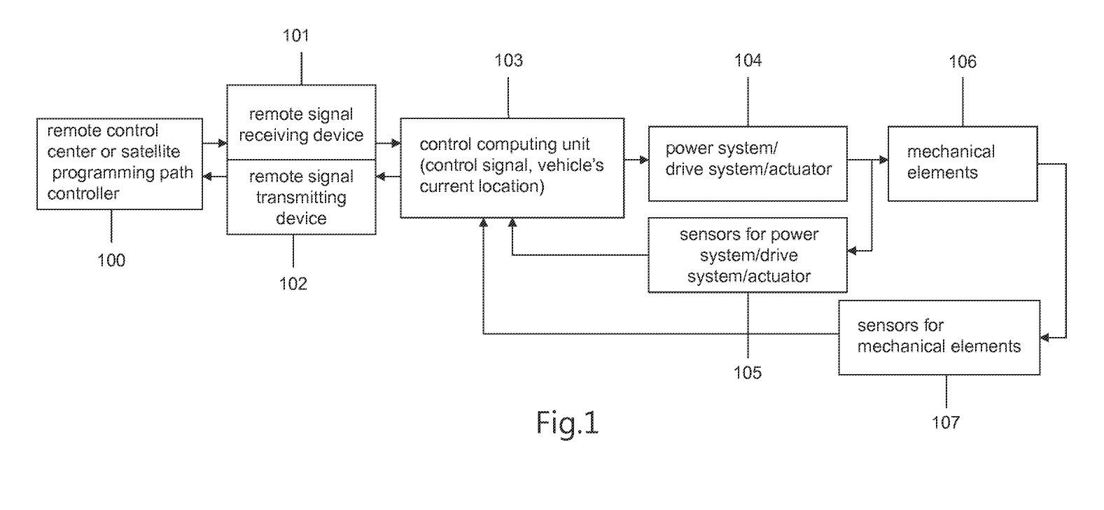

FIG. 1 shows an operation process of a three-dimensional flywheel mobile carrier according to one embodiment of the invention. As shown in FIG. 1, it indicates a control operation flow chart of the three-dimensional flywheel vehicle. In this embodiment, the carrier is a three-dimensional flywheel mobile vehicle. Control computing unit 103 of three-dimensional flywheel mobile carrier is a control center of the mobile carrier, which can control or process a signal transmitted from other components or devices, or send a signal (for example: three dimensional flywheel vehicle's current position, speed . . . and so on) to other components or devices. For example, the control computing unit 103 sends an activation signal to power system/drive system/actuator 104 of the three-dimensional flywheel mobile carrier, followed by mechanical elements and mechanisms 106 of the three-dimensional flywheel mobile carrier for motion by the power system/drive system/actuator 104. The motion of the mechanical elements 106 comprises a platform rocking, shell rotations, pendulum vibration, etc. Under the motion of the mechanical elements and mechanisms 106, three-dimensional flywheel mobile carrier can linearly move forward or backward, or turn. Speed of linear motion or turning amplitude (angle) of the three dimensional flywheel mobile carrier depends on the motion of the mechanical elements and mechanisms 106. For example, the power system includes engine, and the drive system includes a drive motor. For example, the drive motor and the engine can provide power source to the three dimensional flywheel mobile carrier. In one example, the three dimensional flywheel mobile carrier also includes a power control unit, including a speed sensor to detect speed of mobile vehicle, a throttle sensor to detect operation quantity of the throttle.

Thus, in order to obtain speed of the linear motion or turning angle of three-dimensional flywheel mobile carrier, it requires some sensors 107 to detect motion of mechanical elements. Some sensors 107 may be selected depending on actual requirements and applications. For example, speed sensors are response to speed of three-dimensional flywheel vehicle. In one example, angular velocity of rotation of shell of the mobile carrier can be detected by a speed sensor. The other sensors can detect platform swing, pendulum swing and movement of other components of the vehicle body. For example, a turn sensor can detect angular velocity of rotation around the vertical axis. In the system of the present invention, sensing signals of sensors can be sent to the control computing unit 103 as the vehicle rotates, to calculate traveling speed as well as rotation angle of the vehicle to correctly display the speed and rotation angle.

Furthermore, in one embodiment, after the power system/drive system/actuator 104 of the three-dimensional flywheel is activated, it requires related sensors 105, for detecting the power system, drive system, or actuator. Sensing signals of theses sensors 105 can be sent to the control computing unit 103 as the power system/drive system/actuator 104 is activated, to notice and display the working conditions and performance of the power system/drive system/actuator 104.

In another example, a three-dimensional flywheel carrier of the present invention further includes a remote signal receiving device (or equipment) 101 and a remote signal transmitting device (or equipment) 102. The remote signal receiving device 101 and the remote signal transmitting device 102 are responsible for receiving and transmitting signals between a remote control center and the control computing unit 103. In one example, a remote control center or satellite path-programming controller 100 may control movement of the mobile carrier.

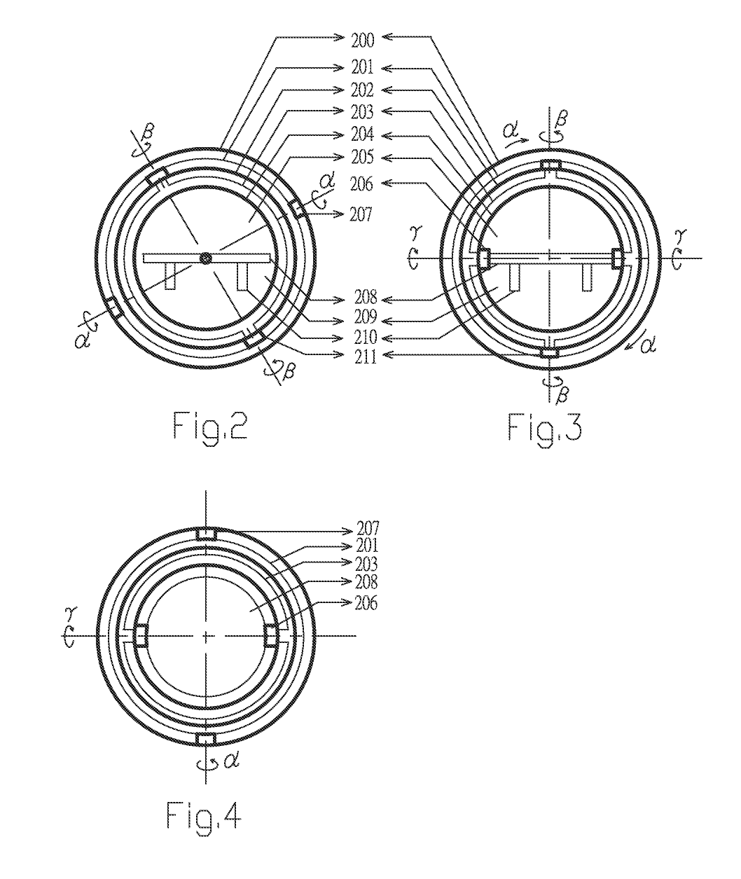

FIGS. 2 and 3 show a front view and a side view of a three-dimensional flywheel mobile vehicle according to the first embodiment of the invention. In this type of the three-dimensional flywheel mobile vehicle, it includes three spherical shells, joint structures connected to the three spherical shells, actuators, platform and steering/equilibrium mechanism (element). The three spherical shells include an outer shell 200, a middle shell 202 and an inner shell 204. The three spherical shells 200, 202, 204 may act as three three-dimensional flywheel of the mobile vehicle. The three spherical shells 200, 202, 204 themselves may store rotational energy or stored by an energy storage device. The three spherical shells 200, 202, 204 may rotate around a first rotation axis (α-axis), a second rotation axis (β-axis), and a third rotation axis (γ-axis). The α-axis, β-axis, and γ-axis are mutually perpendicular.

In one embodiment, the outer shell 200 (α-DOF (degree-of-freedom)) may be driven by α-axis actuator/rotary/motor 207. The outer shell 200 may be rotated around the α-axis, and whereby achieving linear motion of the three-dimensional flywheel mobile vehicle via rotational motion of the outer shell 200, as shown in FIG. 2. The outer shell 200 may directly contact with the outside ground (single-point contact), so that the vehicle is in a neutral stability (non-static stability), and therefore easier to drive.

In one embodiment, the middle shell 202 (β-DOF) may be driven by β-axis actuator/rotary/motor 211. The middle shell 202 may be rotated around the β-axis, achieving the purpose and function of maintaining stability, equilibrium, and turning of the three-dimensional flywheel mobile vehicle via rotational motion and moment of inertia of the middle shell 202, as shown in FIG. 2. As shown in FIG. 2, based-on the front view of the flywheel mobile vehicle, motion of the three-dimensional flywheel mobile vehicle is activated by α-axis actuator/rotary/motor 207 driving the outer shell 200 and β-axis actuator/rotary/motor 211 driving the middle shell 202, respectively.

In one embodiment, the inner shell 204 (γ-DOF) may be driven by γ-axis actuator/rotary/motor 206. The inner shell 204 may be rotated around the γ-axis, achieving the purpose and function of maintaining equilibrium of platform (carrier), and resulting in tilt of the platform to have an included angle with α-axis for facilitating turning of the three-dimensional flywheel mobile vehicle via rotational motion and moment of inertia of the inner shell 204, as shown in FIG. 3. As shown in FIG. 3, based-on the side view of the flywheel mobile vehicle, motion of the three-dimensional flywheel mobile vehicle could be viewed, and activated by β-axis actuator/rotary/motor 211 driving the middle shell 202 and γ-axis actuator/rotary/motor 206 driving the inner shell 204, respectively. Moreover, based-on the top view of the flywheel mobile vehicle, motion of the three-dimensional flywheel mobile vehicle could be viewed, and activated by α-axis actuator/rotary/motor 207 driving the outer shell 200 and γ-axis actuator/rotary/motor 206 driving the inner shell 204, respectively, as shown in FIG. 4.

Therefore, the three-dimensional flywheel vehicle can move through rotation of the outer shell 200, the middle shell 202 and the inner shell 204. The outer shell 200 is responsible for linear (straight line) motion of the mobile vehicle, while the middle shell 202 and the inner shell 204 are responsible for the vehicle's turning, balance and stability. Thus, the outer shell 200, the middle shell 202 and the inner shell 204 construct 3D flywheels, which should have all very similar characteristics of dynamic response, driving and energy storage to modern 2D flywheels. In addition, material of the outer shell 200, the middle shell 202 and the inner shell 204 can be transparent, opaque or trans-opaque.

The joint structures connected to the three spherical shells 200, 202 and 204 comprises an outer casing/frame 201 and an inner casing/frame 203 for connecting to the outer shell 200, the middle shell 202 and the inner shell 204. In one embodiment, the outer casing/frame 201 and/or the inner casing/frame 203 has wires for driving systems. In one embodiment, the outer casing/frame 201 or the inner casing/frame 203 is unlikely to rotate along with rotation's motion of the three spherical shells 200, 202 and 204 (3D flywheel). In one embodiment, bottom of the actuator may be fixed on the outer casing/frame 201 or the inner casing/frame 203. In another embodiment, the actuator may be jointed to the outer casing/frame 201 or the inner casing/frame 203 for sliding along rail thereof such that the outer casing/frame 201 and the inner casing/frame 203 is unlikely to rotate along with rotation's motion of the three spherical shells when the actuator activates the shell. For example, bottom of α-axis actuator/rotary/motor 207, β-axis actuator/rotary/motor 211 and γ-axis actuator/rotary/motor 206 are fixed on or jointed to the outer casing/frame 201 or the inner casing/frame 203 via a sliding joint. In one embodiment, one end of a rotator of α-axis actuator/rotary/motor 207 is connected to the outer shell 200 for driving the outer shell 200, one end of a rotator of β-axis actuator/rotary/motor 211 is connected to the middle shell 202 for driving the middle shell 202, and one end of a rotator of γ-axis actuator/rotary/motor 206 is connected to the inner shell 204 for driving the inner shell 204. Number of α-axis actuator/rotary/motor 207, β-axis actuator/rotary/motor 211 and γ-axis actuator/rotary/motor 206 may be more than one, depending on actual needs and applications.

The platform 208 of the three-dimensional flywheel vehicle is disposed with the inner shell 204 for dividing the inner shell 204 into upper chamber 205 and lower chamber 209. In one embodiment, the upper chamber 205 allows for human's manipulation apparatus or devices disposed thereon, such as control panel (for communication), monitoring screen, main control room, driver (passengers), and cargo storage room. The control panel, the monitoring screen, and the main control room may be disposed on front portion of the upper chamber 205 for facilitating human's identification and control, driver located on the platform 208, and cargo storage room disposed on rear portion of the upper chamber 205. In one embodiment, the lower chamber 209 allows for driving-related apparatus or devices of the three-dimensional flywheel vehicle, such as mechanical equipment with electronic circuit, battery and power system, servo controller, sensing element/antenna/satellite signal receiver, pendulum balancing system (mechanism). However, the above example of the upper chamber 205 and lower chamber 209 is configured only one embodiment, the upper chamber 205 and lower chamber 209 is not limited to such configuration, classification or type; other configuration or any combination of the inner space is still within the scope of the present invention.

A balance mechanism 210 is disposed under the platform 208. For example, the balance mechanism 210 is equipped with a pendulum system, a driving element and an electrical control element. The driving element is used to drive the pendulum. When the pendulum swings, the pendulum moves back and forth. In another embodiment, the balance mechanism 210 is equipped with gyro system. A gyro system is a device for measuring and maintaining a sense of direction, including a rotatable rotor located on center of the axis. In this example, the drive element is used to drive the gyro device. The platform 208 replies to equilibrium in order to maintain a stability of vehicle body by the pendulum or gyro motion. The electronic control devices are used to control the vehicle in order to maintain balance of the platform 208, to be unable to reverse. In one embodiment, the balance mechanism 210 is engaged to the platform 208 by knuckle joint (connector). The steering system of the present invention can also use the pendulum (gyro) of the balance mechanism 210 to change center of gravity of the vehicle body to produce component of force, in order to transform direction of motion, maintain dynamic balancing, control the vehicle's steering, and/or stability of the vehicle body.

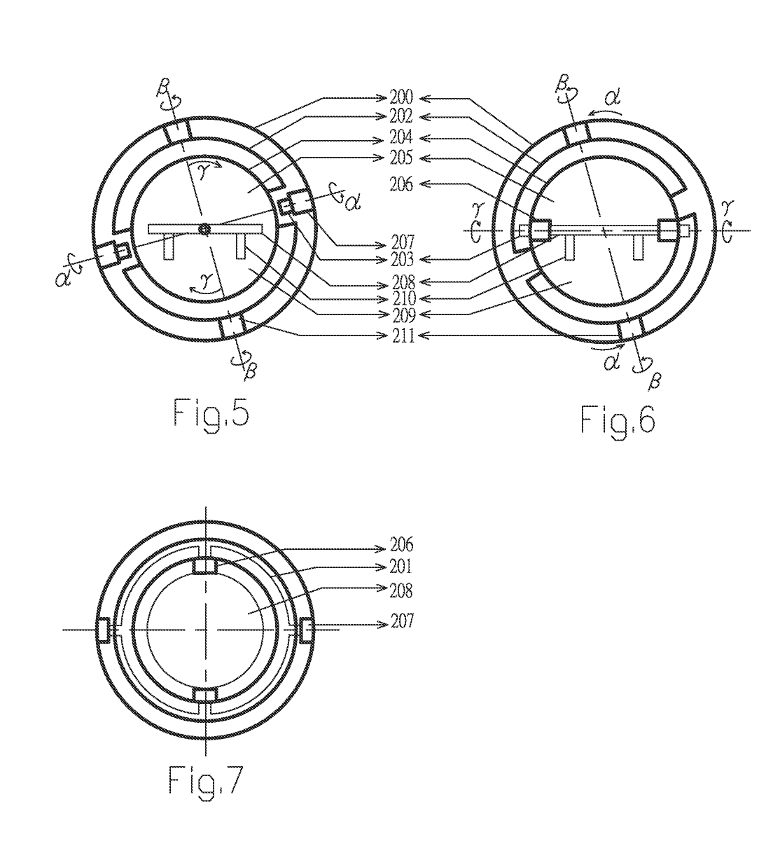

FIGS. 5 and 6 show a front view and a side view of a three-dimensional flywheel mobile vehicle according to the second embodiment of the invention. In this type of the three-dimensional flywheel mobile vehicle, it includes three spherical shells, joint structures connected to the three spherical shells, actuators, platform and steering/equilibrium mechanism (element). The middle shell 202 is made by two hemispherical structures (shells). In one embodiment, upper hemispherical structure is connected to lower hemispherical structure. The three spherical shells include an outer shell 200, a middle shell 202 and an inner shell 204. The three spherical shells 200, 202, 204 may act as three three-dimensional flywheel of the mobile vehicle. The three spherical shells 200, 202, 204 may rotate around a first rotation axis (α-axis), a second rotation axis (β-axis), and a third rotation axis (γ-axis). The α-axis, β-axis, and γ-axis are mutually perpendicular. Function and driving method of the three spherical shells 200, 202, 204 may be referred to the first embodiment, and the detailed description is omitted.

In this embodiment, the joint structure includes only one casing/frame 201 for connecting to the outer shell 200 and the inner shell 204. In one embodiment, the casing/frame 201 has driving elements for 3D flywheel or wires, configured thereon. In one embodiment, the casing/frame 201 is unlikely to rotate along with rotation's motion of the three spherical shells 200, 202 and 204 (3D flywheel). In one embodiment, bottom of the actuator may be fixed on the casing/frame 201. In another embodiment, the actuator may be sliding joint to the casing/frame 201 for sliding along rail thereof such that the casing/frame 201 is unlikely to rotate along with rotation's motion of the three spherical shells when the actuator activates the shell. For example, bottom of α-axis actuator/rotary/motor 207, γ-axis actuator/rotary/motor 206 are fixed on or sliding joint to the casing/frame 201. The β-axis actuator/rotary/motor 211 is fixed on the outer shell 200. In one embodiment, one end of a rotator of α-axis actuator/rotary/motor 207 is connected to the outer shell 200 for driving the outer shell 200, one end of a rotator of β-axis actuator/rotary/motor 211 is connected to the middle shell 202 for driving the middle shell 202, and one end of a rotator of γ-axis actuator/rotary/motor 206 is connected to the inner shell 204 for driving the inner shell 204. Number of α-axis actuator/rotary/motor 207, β-axis actuator/rotary/motor 211 and γ-axis actuator/rotary/motor 206 may be more than one, depending on actual needs or applications for choice or change.

As shown in FIG. 5, based-on the front view of the flywheel mobile vehicle, motion of the three-dimensional flywheel mobile vehicle could be viewed, and activated by α-axis actuator/rotary/motor 207 driving the outer shell 200 and β-axis actuator/rotary/motor 211 driving the middle shell 202, respectively. As shown in FIG. 6, from the side view of the flywheel mobile vehicle, motion of the three-dimensional flywheel mobile vehicle could be viewed, and activated by β-axis actuator/rotary/motor 211 driving the middle shell 202 and γ-axis actuator/rotary/motor 206 driving the inner shell 204, respectively. Moreover, based-on the top view of the flywheel mobile vehicle, motion of the three-dimensional flywheel mobile vehicle could be viewed, and activated by α-axis actuator/rotary/motor 207 driving the outer shell 200 and γ-axis actuator/rotary/motor 206 driving the inner shell 204, respectively, as shown in FIG. 7. In one embodiment, bottom of α-axis actuator/rotary/motor 207 and γ-axis actuator/rotary/motor 206 is fixed on a surface and its opposite surface of the casing/frame 201, respectively, and therefore they can be sliding along the opposite surface.

In this embodiment, the platform 208 and the balance mechanism 210 of the flywheel mobile vehicle may be referred to the first embodiment.

The advantages of the present invention comprises: i). when the vehicle is impacted by an external body: (a) power source of all three dimensional flywheels turns off, by free rolling and sliding of spherical vehicle body to release the impacted energy, but internal seat still maintains balance; (b) the impacted energy can be rapidly dispersed over the whole spherical shells, to avoid a single point localized severe deformation, and thus reducing passengers casualties because of deformation caused by vehicle body; ii). spherical shell design is also a three-dimensional flywheel, stored kinetic energy of rotating capable of transforming into reciprocating motion; since only a single point contacts with ground, the vehicle is easier to be driven; iii). utilizing pendulum (or gyro) to change the center of gravity of the vehicle body motion for generating component of force to change the direction of movement or maintain balance, this design does not require complicated mechanism and steering drive energy (when the vehicle body stops advancing or stationary, motion of single or multiple pendulums maintain the vehicle stability and balance); iv). vehicle shell itself is a flywheel, so steering link mechanism is no need, which reduce vehicle's body weight; v). mobile phone can be used to control driving of the vehicle, or remote control motion of the vehicle.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. A three dimensional flywheel vehicle, comprising:
three spherical shells, including an outer shell, a middle shell and an inner shell;
at least one joint structure connected to said three spherical shells; and
a plurality of actuators having a first actuator, a second actuator and a third actuator for driving said outer shell, said middle shell and said inner shell, respectively, wherein said first actuator, said second actuator or said third actuator is connected to or sliding joint to one of said at least one joint structure or one of said three spherical shells.

2. The vehicle of claim 1, further comprising a platform disposed within said inner shell for dividing said inner shell into an upper chamber and a lower chamber.

3. The vehicle of claim 2, wherein said upper chamber is equipped with a control panel, a monitoring screen, a main control room, and a cargo storage room.

4. The vehicle of claim 2, wherein said lower chamber is equipped with mechanical equipments, electronic circuits, battery and power systems, servo controllers, sensing elements, and balancing mechanisms.

5. The vehicle of claim 4, wherein said balancing mechanism include a pendulum or a gyro.

6. The vehicle of claim 1, wherein said one end of a first rotator of said first actuator is connected to said outer shell, one end of a second rotator of said second actuator is connected to said middle shell, and one end of a third rotator of said third actuator is connected to said inner shell.

7. The vehicle of claim 1, wherein at least one joint structure is a single joint structure.

8. The vehicle of claim 7, wherein a bottom of said first actuator is fixed on said single joint structure, a bottom of said second actuator fixed on said outer shell, and a bottom of said third actuator fixed on said single joint structure.

9. The vehicle of claim 7, wherein said single joint structure is connected to said outer shell and said middle shell.

10. The vehicle of claim 8, wherein said middle shell is made by two hemispherical structures.

11. The vehicle of claim 1, wherein said outer shell, said middle shell and said inner shell are rotating around a first rotation axis, a second rotation axis and a third rotation axis, respectively.

12. The vehicle of claim 11, further comprising a platform disposed within said inner shell for dividing said inner shell into an upper chamber and a lower chamber.

13. The vehicle of claim 12, wherein said upper chamber is equipped with a control panel, a monitoring screen, a main control room, and a cargo storage room.

14. The vehicle of claim 12, wherein said upper chamber is equipped with mechanical equipments, electronic circuits, battery or power systems, servo controllers, sensing elements, and balancing mechanisms.

15. The vehicle of claim 14, wherein said balancing mechanism include a pendulum or a gyro system.

16. The vehicle of claim 11, wherein said one end of a first rotator of said first actuator is connected to said outer shell, one end of a second rotator of said second actuator is connected to said middle shell, and one end of a third rotator of said third actuator is connected to said inner shell.

17. The vehicle of claim 11, wherein at least one joint structure is a single joint structure.

18. The vehicle of claim 17, wherein a bottom of said first actuator is fixed on said single joint structure, a bottom of said second actuator fixed on said outer shell, and a bottom of said third actuator fixed on said single joint structure.

19. The vehicle of claim 17, wherein said single joint structure is connected to said outer shell and said inner shell.

20. The vehicle of claim 18, wherein said middle shell is made by two hemispherical structures.
